(19) United States
(12) Patent Application Publication
(10) Pub. No.: US 2007/0086145 A1
(43) Pub. Date: Apr. 19, 2007

(54) Capacitor-built-in substrate and method of manufacturing the same

(75) Inventors: Kazuyuki Kubota, Nagano (JP); Tomoharu Fujii, Nagano (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SHINKO ELECTRIC INDUSTRIES CO., LTD., Nagano-shi (JP)

(21) Appl. No.: 11/546,889

(22) Filed: Oct. 13, 2006

(30) Foreign Application Priority Data
Oct. 17, 2005 (JP) 2005-301704

(51) Int. Cl. H01G 4/06

(52) U.S. Cl. 361/311

(57) ABSTRACT

A capacitor-built-in substrate of the present invention contains a capacitor which includes a lower common electrode, a plurality of dielectric portions formed on the lower common electrode to be isolated mutually and coupled electrically to the lower common electrode, an insulating layer formed between the plurality of dielectric portions and on a surrounding area, and an upper common electrode formed on the plurality of dielectric portions and the insulating layer, and coupled electrically to the plurality of dielectric portions.

### CROSS-REFERENCE TO RELATED APPLICATIONS

This application is based on and claims priority of Japanese Patent Application No. 2005-301704 filed on Oct. 17, 2005, the entire contents of which are incorporated herein by reference.

### BACKGROUND OF THE INVENTION

1. Field of the Invention

The present invention relates to a capacitor-built-in substrate and a method of manufacturing the same and more particularly, a capacitor-built-in substrate which can be applied to a technology of the decoupling capacitor which is arranged in a circuit substrate into which high-speed electronic components are mounted, and which can stabilizes a power supply voltage and can reduce a high-frequency noise, and a method of manufacturing the same.

2. Description of the Related Art

In the digital LSIs including the microprocessor, a reduction in a power supply voltage on account of an increase in processing speed and a decrease in consumption power is being advanced nowadays. In such digital LSIs, a power supply voltage of the LSI is apt to become unstable when the impedance of the LSI is suddenly changed, or the like. Also, the more stable operation in a high-frequency (GHz band) range is required of the high-speed digital LSI. Thereby, prevention of malfunction in the LSI caused due to a high-frequency noise is needed.

Therefore, for the purpose of stabilizing a power supply voltage and reducing a high-frequency noise, the decoupling capacitor is arranged between a power-supply line and a ground line of the LSI in the circuit substrate.

As the characteristic of the decoupling capacitor, it is desired that the impedance is sufficiently low in the high-frequency band. In Patent Literature 1 (Patent Application Publication (KOKAI) 2005-191266), it is set forth that a plurality of capacitors having mutually a different electrostatic capacity are constructed into one chip, so that the impedance can be reduced over the broad frequency band. Also, in Patent Literature 2 (Patent Application Publication (KOKAI) 2005-72311), it is set forth that one capacitor is constructed by dividing the electrode such that polarities (+, −) of neighboring electrode terminals are alternately arranged, so that the inductance can be reduced to improve the high-frequency characteristic.

Also, in Patent Literature 3 (Patent Application Publication (KOKAI) 2005-129649), it is set forth that a capacitor portion having such a structure that the dielectric member is arranged between the power-supply line and the ground line which are arranged in parallel in the vertical direction, are aligned in the horizontal direction by plurality, so that the electrostatic capacity of the capacitor can be enlarged and also the impedance can be reduced.

Recently the larger electrostatic capacity is required of the decoupling capacitor. When the capacitor having the large capacity is constructed by one block (lower electrode/dielectric member/upper electrode), such capacitor has a relatively large ESL (Equivalent Series Inductance) and thus its resonance frequency becomes low and in many cases a desired high-frequency characteristic cannot be achieved. It is effective for such problem that one capacitor should be constructed by a plurality of divided capacitors, as set forth in Patent Literature 1.

However, when one capacitor is constructed by a plurality of capacitors, the electrodes are provided to individual capacitors. Therefore, in order to connect a plurality of capacitors in parallel, the common electrode must be rewired over the circuit substrate in which the capacitor is built in via the interlayer insulating layer. As a result, since the leading wirings are needed upon forming the capacitor in the circuit substrate to be built in there, such problems arise that a mounting area is increased and also a wiring layout on the circuit substrate is restricted.

### SUMMARY OF THE INVENTION

It is an object of the present invention to provide a capacitor-built-in substrate, which can achieve a desired high-frequency characteristic even when a high electrostatic capacity is required of the capacitor and in which the capacitor can be built in with a simple electrode structure, and a method of manufacturing the same.

The present invention is concerned with a capacitor-built-in substrate, the capacitor of which includes a lower common electrode; a plurality of dielectric portions formed on the lower common electrode to be isolated mutually, and coupled electrically to the lower common electrode; an insulating layer formed between the plurality of dielectric portions and on a surrounding area; and an upper common electrode formed on the plurality of dielectric portions and the insulating layer, and coupled electrically to the plurality of dielectric portions.

In the capacitor of the capacitor-built-in substrate of the present invention, a plurality of dielectric portions isolated mutually are formed on the lower common electrode, then the insulating layer is formed between the dielectric portions and the surrounding area, and then the upper common electrode is provided on the dielectric portions and the insulating layer.

In this manner, a plurality of dielectric portions are arranged to be put between the lower common electrode and the upper common electrode such that a plurality of capacitor portions are connected electrically in parallel to constitute one capacitor.

When the dielectric portions are formed of patterns of the dielectric layer, the lower common electrode and the upper common electrode contact directly the dielectric portions and are coupled electrically to the dielectric portions respectively. Alternately, the dielectric portions may be formed of the dielectric portion of the capacitor component having a pair of electrodes. In the case of this mode, a plurality of capacitor components are arranged between the lower common electrode and the lower common electrode to contact directly them, and the lower common electrode and the upper common electrode are coupled electrically to the dielectric portions via the electrodes of the capacitor component.

As described above, in the present invention, a plurality of divided dielectric portions (patterned dielectric layers or capacitor component) are arranged to be put directly between the lower common electrode and the upper common electrode. For this reason, unlike the prior art, it is not needed that a plurality of capacitors having their own electrodes individually should be formed and then respective electrodes should be rewired to the common electrode formed over there via the interlayer insulating layer. Therefore, the troublesome wiring provision is not needed in building the capacitor in the substrate. As a result, a mounting area can be reduced and also a wiring layout on the circuit substrate is not restricted at all.

Also, the capacitor of the present invention is constructed by dividing one capacitor into capacitor portions whose electrostatic capacity is small and then connecting in parallel these capacitor portions. As a result, even when the capacitor of the present invention is employed as the capacitor whose electrostatic capacity is relatively large (for example, almost 9 pF), the resonance frequency of this capacitor can be made high and also the impedance can be reduced rather than the capacitor that has the equivalent electrostatic capacity and is not divided.

As explained above, according to the capacitor-built-in substrate of the present invention, the capacitor can be built in the substrate with a simple electrode structure, and also the high frequency characteristic of the capacitor can be improved.

### BRIEF DESCRIPTION OF THE DRAWINGS

FIGS. 1A to 1H are sectional views showing a method of manufacturing a capacitor-built-in substrate according to a first embodiment of the present invention;

FIG. 2 is a sectional view showing the capacitor-built-in substrate according to the first embodiment of the present invention;

FIG. 3 is a sectional view showing a capacitor-built-in substrate according to a variation of the first embodiment of the present invention;

FIG. 4 is a chart showing a simulation result of the reflection characteristic (S11) in a high frequency band of the capacitor according to the first embodiment of the present invention;

FIGS. 5A and 5B are sectional views (containing a fragmental plan view) showing a method of manufacturing a capacitor-built-in substrate according to a second embodiment of the present invention, wherein a sectional view in FIG.5A shows a sectional shape taken along a II-II line in the plan view;

FIG. 6 is a sectional view showing the capacitor-built-in substrate according to the second embodiment of the present invention;

FIGS. 7A and 7B are sectional views (containing a fragmental plan view) showing a method of manufacturing a capacitor-built-in substrate according to a third embodiment of the present invention, wherein a sectional view in FIG. 7A shows a sectional shape taken along a III-III line in the plan view;

FIG. 8 is a sectional view showing the capacitor-built-in substrate according to the third embodiment of the present invention; and

FIG. 9 is a sectional view showing a capacitor-built-in substrate according to a variation of the third embodiment of the present invention.

### DETAILED DESCRIPTION OF THE PREFERRED EMBODIMENTS

Embodiments of the present invention will be explained with reference to the accompanying drawings hereinafter.

(First Embodiment)

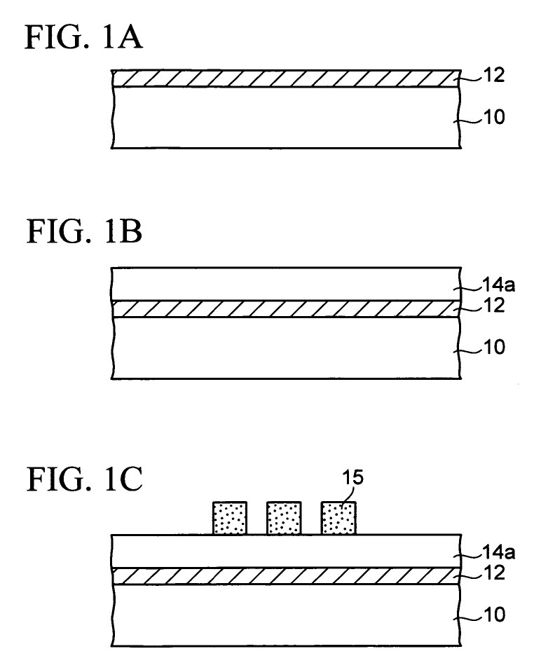

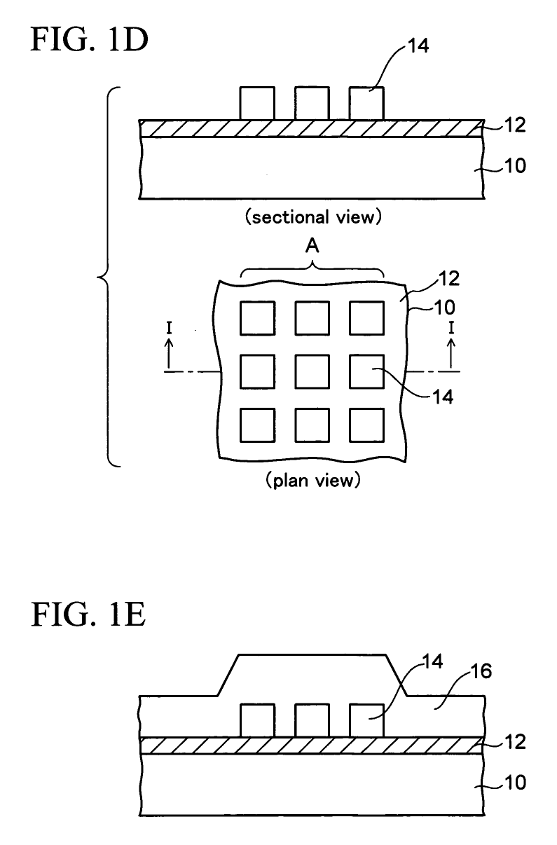

FIGS. 1A to 1H are sectional views (containing a fragmental plan view) showing a method of manufacturing a capacitor-built-in substrate according to a first embodiment of the present invention, and FIG. 2 is a sectional view showing similarly the capacitor-built-in substrate.

As shown in FIG. 1A, first, a capacitor lower common electrode 12 is formed on a substrate 10. The capacitor according to the present embodiment is provided to any layer of the multi-layered circuit substrate to be built in there, and the substrate 10 corresponds to the insulating layer of the multi-layered circuit substrate, for example. Also, in some cases the wiring layer is provided to the insulating layer below the lower common electrode 12.

As the material of the lower common electrode 12, copper (Cu), tantalum (Ta), chromium (Cr), platinum (Pt), gold (Au), tungsten (W), ruthenium (Ru), nickel (Ni), or the like may be employed. The lower common electrode 12 may be formed of either a single-layered metal layer or a laminated metal layer consisting of any combination of these metal materials. Also, the lower common electrode 12 may be provided to the overall surface of the substrate 10 or may be formed as patterned layers.

Then, as shown in FIG. 1B, a dielectric layer 14a is formed on the lower common electrode 12. As the dielectric layer 14a, a metal oxide layer made of BST ((Ba,Sr)TiO₃), STO (SrTiO₃), PZT (Pb(Zr,Ti)O₃), BTO (BaTiO₃), AlOx (alumina), SiOx (silicon oxide), NbOx (niobium oxide), TiOx (titanium oxide), or the like a resin containing fillers of the metal oxides, or the like may be employed. This dielectric layer 14a may be formed the sputter method, the MOCVD (organic metal CVD) method, the sol-gel method, or the like. Alternately, a tantalum oxide layer obtained by anode-oxidizing a surface of a tantalum layer may be utilized as the dielectric layer 14a.

Then, as shown in FIG. 1C, a resist film 15 used to pattern the dielectric layer 14a is formed, and then the dielectric layer 14a is patterned by the etching while using the resist film 15 as a mask. Then, the resist film 15 is removed. Then, as shown in FIG. 1D, a plurality of dielectric portions 14 for the capacitor are formed in an area A, in which one capacitor is to be constructed, in a state that they are separated mutually. As shown in a plan view in FIG. 1D, in the present embodiment, such a mode is exemplified that one capacitor dielectric member is divided into nine dielectric portions 14. But one capacitor dielectric member may be divided into n (n is any integer in excess of 2) dielectric portions 14.

The lower common electrode 12 acts as the common electrode of the capacitor, which comes into contact with respective lower surfaces of a plurality of dielectric portions 14 and are coupled electrically to them.

Then, as shown in FIG. 1E, a first insulating layer 16 made of an epoxy resin, or the like is formed to cover a plurality of dielectric portions 14. Then, as shown in FIG. 1F, the first insulating layer 16 is polished until upper surfaces of a plurality of dielectric portions 14 are exposed such that the first insulating layer 16 is left between a plurality of dielectric portions 14 and on a surrounding area. Accordingly, a plurality of dielectric portions 14 are embedded in the first insulating layer 16 to expose their upper surfaces, so that level differences between a plurality of dielectric portions 14 can be eliminated and their upper surfaces are made flat.

Then, as shown in FIG. 1G, a metal layer is formed on the dielectric portions 14 and the first insulating layer 16. Then, an upper common electrode 18 of the capacitor is formed by patterning the metal layer in terms of the photolithography and the etching. Thus, the upper common electrode 18 acts as the common electrode of the capacitor, which comes into contact with respective upper surfaces of a plurality of dielectric portions 14 and are coupled electrically to them. As the metal material of the upper common electrode 18, the metal similar to the foregoing lower common electrode 12 is employed.

Then, as shown in FIG. 1H, a second insulating layer 20 (upper insulating layer) made of an epoxy resin, or the like is formed to cover the upper common electrode 18. A via hole 20x whose depth reaches the upper common electrode 18 is formed by processing the second insulating layer 20 in terms of the laser.

Then, as shown in FIG. 2, a leading wiring layer 22 that is connected electrically to the upper common electrode 18 via the via hole 20x is formed on the second insulating layer 20 by the semi-additive approach, or the like.

With the above, a capacitor-built-in substrate 1 containing a capacitor C according to the first embodiment can be obtained.

As shown in FIG. 2, in the capacitor-built-in substrate 1 according to the present embodiment, the lower common electrode 12 is formed on the substrate 10 (the insulating layer, or the like of the multi-layered circuit substrate) and a plurality of patterned dielectric portions 14 are formed thereon to be isolated mutually. The first insulating layer 16 is formed between a plurality of dielectric portions 14 and on a surrounding area such that a plurality of dielectric portions 14 are embedded in the first insulating layer 16. Also, the upper common electrode 18 that contacts respective upper surfaces of a plurality of dielectric portions 14 is formed on the dielectric portions 14 and the first insulating layer 16.

In this manner, one capacitor is composed of the lower common electrode 12, a plurality of dielectric portions 14, and the upper common electrode 18. In more detail, the lower common electrode 12 and the upper common electrode 18 are formed on the lower surfaces and the upper surfaces of a plurality of dielectric portions 14 respectively to contact mutually, and accordingly a plurality of capacitor portions Cx are constructed. Then, a plurality of capacitor portions Cx are connected electrically in parallel to constitute the capacitor C.

Then, the second insulating layer 20 in which the via hole 20x is provided on the upper common electrode 18 is formed on the capacitor C. Then, the leading wiring layer 22 that is connected electrically to the upper common electrode 18 via the via hole 20x is formed on the second insulating layer 20.

In the capacitor C of the present embodiment, a plurality of isolated dielectric portions 14 are put directly between the lower common electrode 12 and the upper common electrode 18. For this reason, unlike the prior art, it is not needed that a plurality of capacitors having their own electrodes individually should be formed and then respective electrodes should be rewired to the common electrode formed over there via the interlayer insulating layer. Therefore, the troublesome wiring provision is not needed in building the capacitor C consisting of a plurality of capacitor portions Cx in the substrate 10. As a result, a mounting area can be reduced and also a wiring layout on the circuit substrate is never restricted.

In the present embodiment, the lower common electrode 12 serves as the ground line of the circuit substrate on which the semiconductor chip, and the like is mounted, and the upper common electrode 18 serves as the power supply line of the circuit substrate. Also, the capacitor C is provided between the power supply line and the ground line and acts as the decoupling capacitor. In the capacitor-built-in substrate 1 in FIG. 2, only the concerned portion of the multi-layered circuit substrate containing the built-in capacitor is shown and illustration of the signal line is omitted herein. Also, in some case the capacitor C is inserted into the high-frequency signal line of the multi-layered circuit substrate.

Alternately, the capacitor-built-in substrate 1 of the present embodiment can be employed solely as the capacitor component.

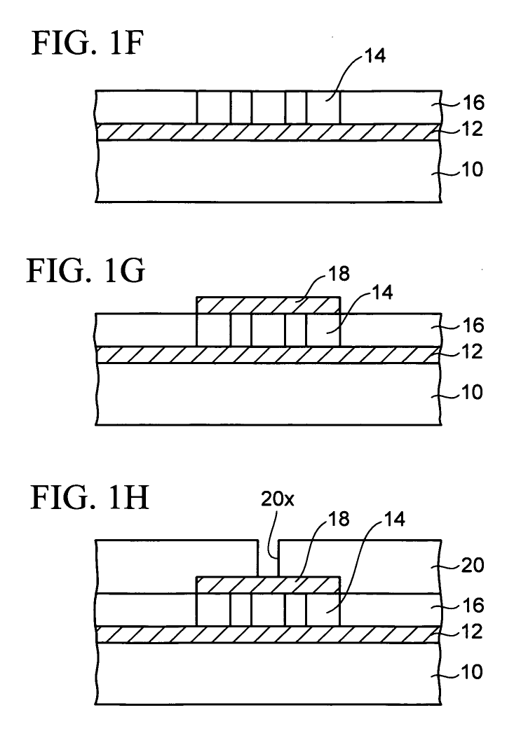

A capacitor-built-in substrate la according to a variation of the first embodiment of the present invention is shown in FIG. 3. As shown in FIG. 3, when there is a necessity to connect the lower common electrode 12 to the leading wiring layer 22, a via hole 20y having a depth that reaches the lower common electrode 12 may be formed in the first and second insulating layers 16, 20 and then the lower common electrode 12 may be connected to the leading wiring layer 22 via the via hole 20y.

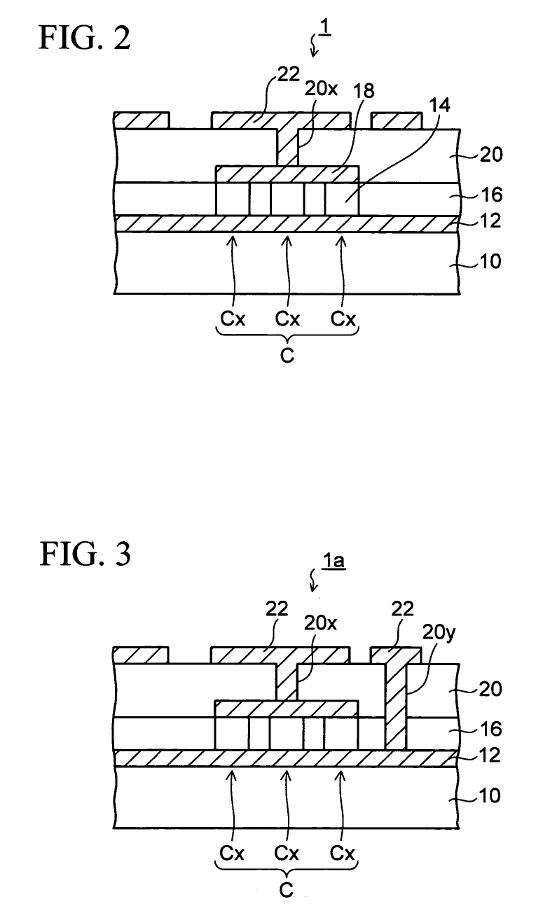

FIG. 4 shows a simulation result of the reflection characteristic (S11) in the high frequency band of the capacitor according to the present embodiment. A thick line shows the S11 characteristic of the capacitor (electrostatic capacity: 1×9 pF) of the present embodiment, which is constructed by connecting in parallel nine capacitors whose electrostatic capacity is 1 pF. A broken line shows the S11 characteristic of the capacitor (electrostatic capacity: 9 pF) that is not divided. A thin line shows the S11 characteristic of the capacitor (electrostatic capacity: 1 pF) that is not divided.

As shown in FIG. 4, a resonance frequency of the capacitor (electrostatic capacity: 9 pF) that is not divided is almost 2.3 GHz, while a resonance frequency of the capacitor (electrostatic capacity: 1×9 pF) of the present embodiment is increased up to almost 7 GHz, which yields the resonance frequency that is substantially equivalent to that of the capacitor whose electrostatic capacity is small (1 pF). In this manner, the capacitor of the present embodiment is constructed by connecting in parallel a plurality of capacitors whose electrostatic capacity is small. As a result, even when the capacitor of the present embodiment is used as the capacitor whose electrostatic capacity is relatively large (almost 9 pF), the resonance frequency of this capacitor can be set high rather than the capacitor that has the equivalent electrostatic capacity and is not divided.

Also, the S11 value of the capacitor of the present embodiment is reduced lower than the capacitors (electrostatic capacity: 9 pF and 1 pF) that are not divided. It is appreciated that the capacitor of the present embodiment is effective in reducing the impedance.

As described above, in the capacitor of the present embodiment, even when the capacitor of the present embodiment is used as the capacitor whose electrostatic capacity is relatively large, the resonance frequency can be increased and also the impedance can be reduced. As a result, the capacitor of the present embodiment can give the enough performance as the decoupling capacitor for the high-speed electronic component (semiconductor chip).

(Second Embodiment)

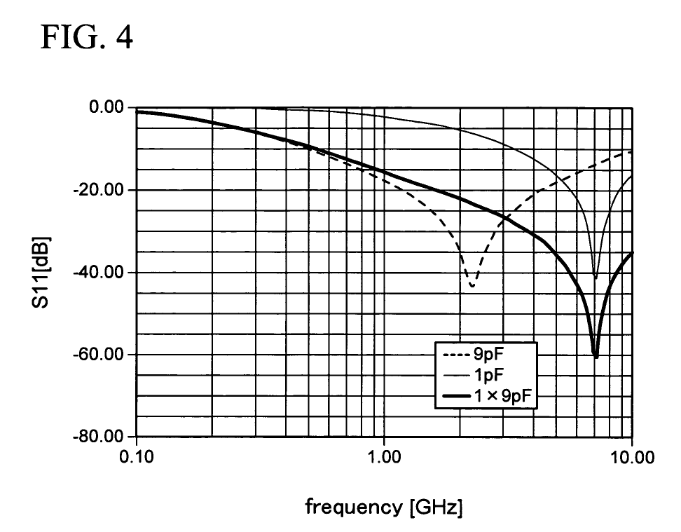

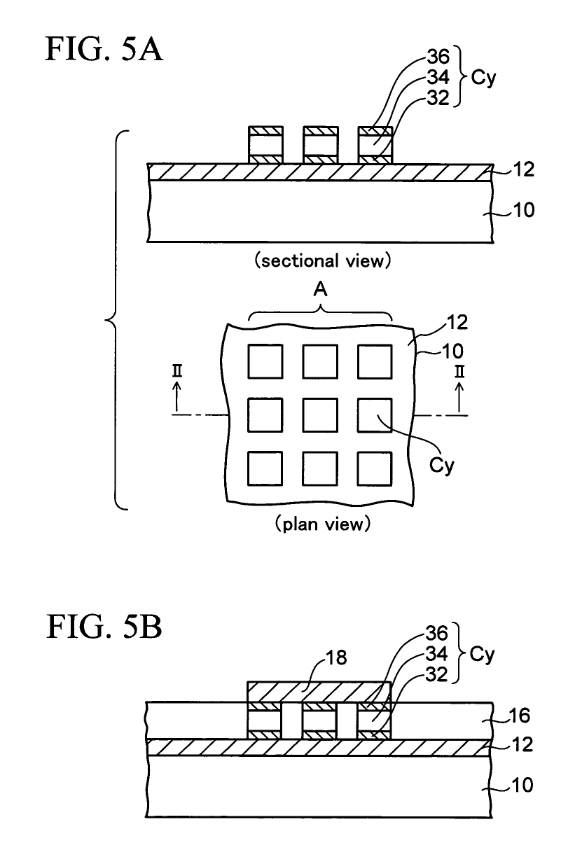

FIGS. 5A and 5B are sectional views (containing a fragmental plan view) showing a method of manufacturing a capacitor-built-in substrate according to a second embodiment of the present invention. FIG. 6 is a sectional view showing similarly the capacitor-built-in substrate. A feature of the second embodiment resides in that one capacitor is constructed by a plurality of capacitor components based on the similar technical idea to the first embodiment. The same reference symbols are affixed to the same elements as those in the first embodiment, and their detailed explanation will be omitted herein.

As shown in FIG. 5A, first, a plurality of capacitor components Cy are mounted on the lower common electrode 12 formed on the substrate 10. Each of the capacitor components Cy is constructed by a cubic dielectric portion 34, and a first electrode 32 and a second electrode 36 (a pair of electrodes) that are formed on an upper surface and a lower surface of the dielectric portion 34 to put it therebetween. Then, the first electrodes 32 of the capacitor components Cy are secured to the lower common electrode 12 with a conductive adhesive (not shown) such that the first electrode 32 and the second electrode 36 are aligned in the vertical direction. Accordingly, the lower common electrode 12 is coupled electrically to a plurality of dielectric portions 34 via the first electrodes 32 of respective capacitor components Cy.

In a plan view in FIG. 5A, an example where nine capacitor components Cy are arranged in the area A in which one capacitor is constructed is shown, like the first embodiment.

Then, as shown in FIG. 5B, the first insulating layer 16 is embedded between a plurality of capacitor components Cy and on the surrounding area by the method similar to the first embodiment. Then, the upper common electrode 18 connected to the second electrodes 36 of a plurality of capacitor components Cy are formed on the capacitor components Cy and the first insulating layer 16. As a result, the upper common electrode 18 is coupled electrically to a plurality of dielectric portions 34 via the second electrodes 36 of respective capacitor components Cy.

Then, as shown in FIG. 6, like the first embodiment, the second insulating layer 20 for covering the upper common electrode 18 is formed, and then the via hole 20x is formed in a portion of the second insulating layer 20 on the upper common electrode 18. Then, the leading wiring layer 22 connected electrically to the upper common electrode 18 via the via hole 20x is formed on the second insulating layer 20.

With the above, a capacitor-built-in substrate 1b of the second embodiment can be obtained. In the second embodiment, a plurality of capacitor components Cy each having such a structure that the first electrode 32 and the second electrode 36 are formed on the lower surface and the upper surface of the dielectric portion 34 respectively are put directly between the lower common electrode 12 and the upper common electrode 18. Also, the lower common electrode 12 is coupled electrically to a plurality of dielectric portions 34 via the first electrodes 32 of respective capacitor components Cy, and also the upper common electrode 18 is coupled electrically to a plurality of dielectric portions 34 via the second electrodes 36 of respective capacitor components Cy. In this fashion, a plurality of capacitor components Cy are connected electrically in parallel and the capacitor C of the present embodiment is constructed.

In the second embodiment, for the same reason as the first embodiment, a mounting area can be reduced upon building the capacitor consisting of a plurality of capacitor components Cy in the substrate 10, and also the wiring layout of the circuit substrate is not restricted at all.

Also, in the second embodiment, like the variation of the first embodiment, the lower common electrode 12 may be connected to the leading wiring layer 22 via the via hole.

(Third Embodiment)

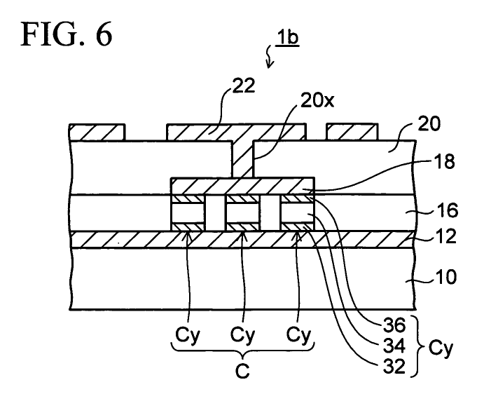

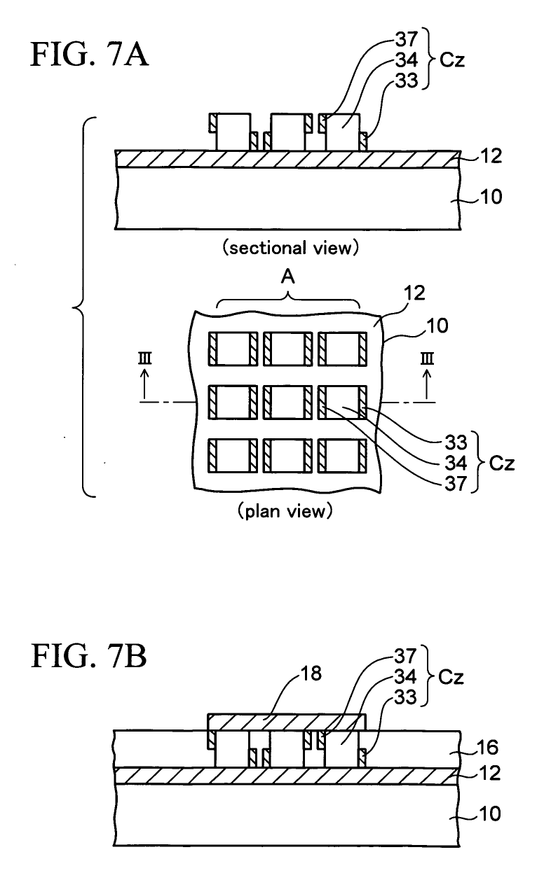

FIGS. 7A and 7B are sectional views (containing a fragmental plan view) showing a method of manufacturing a capacitor-built-in substrate according to a third embodiment of the present invention. FIG. 8 is a sectional view showing similarly the capacitor-built-in substrate. A feature of the third embodiment resides in that the capacitor components of the third embodiment are different in structure from those of the second embodiment. Therefore, the same reference symbols are affixed to the same elements as those in the second embodiment, and their detailed explanation will be omitted herein.

In the third embodiment, as shown in FIG. 7A, first, a plurality of capacitor components Cz are mounted on the lower common electrode 12 formed on the substrate 10. Each of the capacitor components Cz of the third embodiment is constructed by the cubic dielectric portion 34, a first electrode 33 provided to a lower area of one side surface of the dielectric portion 34, and a second electrode 37 provided to an upper area of the opposite side surface of the dielectric portion 34.

A plurality of capacitor components Cz are secured to the lower common electrode 12 with a conductive adhesive (not shown) such that the first electrode 33 and the second electrode 37 of the capacitor components Cz are aligned in the lateral direction and also the first electrodes 33 are connected electrically to the lower common electrode 12. At this time, a plurality of capacitor components Cz are aligned in such a manner that the first electrodes 33 are opposed to each other and the second electrodes 37 are opposed to each other. Accordingly, the lower common electrode 12 is coupled electrically to a plurality of dielectric portions 34 via the first electrodes 33 of respective capacitor components Cz.

In a plan view in FIG. 7A, an example where nine capacitor components Cz are arranged in the area A in which one capacitor is constructed is shown, like the first embodiment.

Then, as shown in FIG. 7B, the first insulating layer 16 is embedded between a plurality of capacitor components Cz and on the surrounding area by the method similar to the first embodiment. Then, the upper common electrode 18 connected to the second electrodes 37 of the capacitor components Cz are formed on the capacitor components Cz and the first insulating layer 16. As a result, the upper common electrode 18 is coupled electrically to a plurality of dielectric portions 34 via the second electrodes 37 of respective capacitor components Cz.

Then, as shown in FIG. 8, like the first embodiment, the second insulating layer 20 for covering the upper common electrode 18 is formed, and then the via hole 20x is formed in a portion of the second insulating layer 20 on the upper common electrode 18. Then, the leading wiring layer 22 connected electrically to the upper common electrode 18 via the via hole 20x is formed on the second insulating layer 20.

With the above, a capacitor-built-in substrate 1c of the third embodiment can be obtained. In the third embodiment, a plurality of capacitor components Cz each constructed by the dielectric portion 34, the first electrode 33 provided to the lower area of one side surface of the dielectric portion 34, and the second electrode 37 provided to the upper area of the opposite side surface of the dielectric portion 34 are put directly between the lower common electrode 12 and the upper common electrode 18. Also, the lower common electrode 12 is coupled electrically to a plurality of dielectric portions 34 via the first electrodes 33 of respective capacitor components Cz, and also the upper common electrode 18 is coupled electrically to a plurality of dielectric portions 34 via the second electrodes 37 of respective capacitor components Cz.

In this manner, a plurality of capacitor components Cz are connected electrically in parallel and the capacitor C of the present embodiment is constructed.

In the third embodiment, for the same reason as the first embodiment, a mounting area can be reduced upon building the capacitor C consisting of a plurality of capacitor components Cz in the substrate 10, and also the wiring layout of the circuit substrate is never restricted.

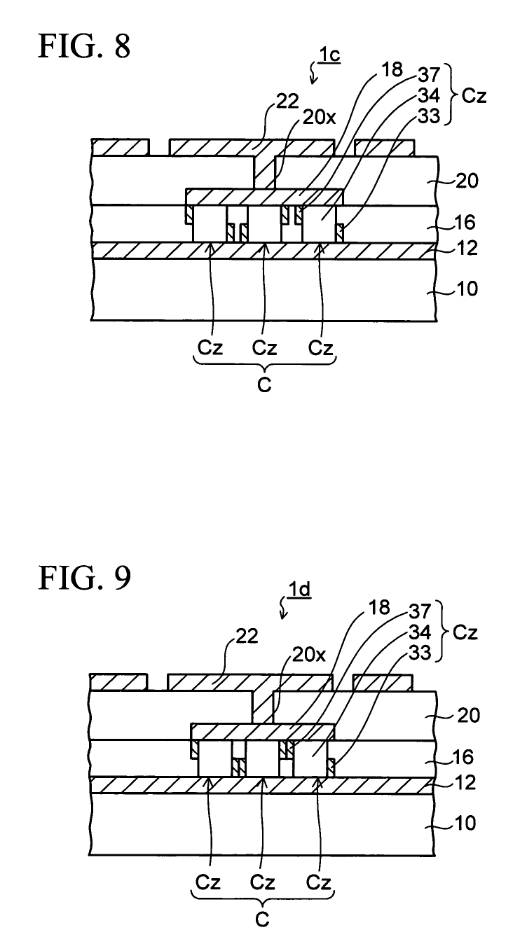

A capacitor-built-in substrate 1d according to a variation of the third embodiment of the present invention is shown in FIG. 9. As shown in FIG. 9, in a plurality of capacitor components Cz in the plan view in FIG. 7A, the opposing first electrodes 33 and the opposing second electrodes 37 of neighboring capacitor components Cz in the lateral direction may be brought into contact with each other respectively to be connected electrically mutually.

Also, in the third embodiment, like the variation of the first embodiment, the lower common electrode 12 may be connected to the leading wiring layer 22 via the via hole.

Also, in the present invention, in addition to the capacitor components illustrated in the second and third embodiments, various capacitor components such as the stacked capacitor, or the like may be employed. Any capacitor may be employed if the lower common electrode and the upper common electrode can be coupled electrically to the dielectric portion via the electrode of the capacitor components.

What is claimed is:

1. A capacitor-built-in substrate, including the capacitor comprising:
a lower common electrode;
a plurality of dielectric portions formed on the lower common electrode to be isolated mutually, and coupled electrically to the lower common electrode;
an insulating layer formed between the plurality of dielectric portions and on a surrounding area; and
an upper common electrode formed on the plurality of dielectric portions and the insulating layer, and coupled electrically to the plurality of dielectric portions.

2. A capacitor-built-in substrate, according to claim 1, wherein the plurality of dielectric portions are formed of patterned dielectric layers, and contact directly the lower common electrode and the upper common electrode.

3. A capacitor-built-in substrate, according to claim 1, wherein the dielectric portions are formed of dielectric portions of capacitor components each having a pair of electrodes, and a plurality of capacitor components are arranged between the lower common electrode and the upper common electrode to contact directly both electrodes, and
the lower common electrode and the upper common electrode are coupled electrically to the dielectric portions via the electrodes of the capacitor components.

4. A capacitor-built-in substrate, according to claim 3, wherein the capacitor components have such a structure that an electrode is provided to an upper surface and a lower surface of the dielectric portion respectively, and are arranged such that the electrodes are aligned in a vertical direction.

5. A capacitor-built-in substrate, according to claim 3, wherein the capacitor components have such a structure that an electrode is provided to an upper area of one side surface and a lower area of an opposite side surface of the dielectric portion respectively, and are arranged such that the electrodes are aligned in a lateral direction.

6. A capacitor-built-in substrate, according to claim 1, further comprising:
an upper insulating layer formed on the upper common electrode;
a via hole formed in a portion of the upper insulating layer on the upper common electrode; and
a leading wiring layer connected to the upper common electrode via the via hole.

7. A capacitor-built-in substrate, according to claim 6, wherein another via hole is formed in a portion of the insulating layer on the lower common electrode, and the lower common electrode is connected to the leading wiring layer via said another via hole.

8. A method of manufacturing a capacitor-built-in substrate, including forming the capacitor by a method comprising the steps of:
forming a lower common electrode;
forming a plurality of dielectric portions, which are isolated mutually and coupled electrically to the lower common electrode, on the lower common electrode;
forming an insulating layer between the plurality of dielectric portions and on a surrounding area; and
forming an upper common electrode, which is coupled electrically to the plurality of dielectric portions, on the plurality of dielectric portions and the insulating layer.

9. A method of manufacturing a capacitor-built-in substrate, according to claim 8, wherein the step of forming the plurality of dielectric portions includes the steps of
forming a dielectric layer on the lower common electrode, and
forming the plurality of dielectric portions by patterning the dielectric layer.

10. A method of manufacturing a capacitor-built-in substrate, according to claim 8, wherein the step of forming the plurality of dielectric portions is a step of mounting capacitor components each composed of electrodes and a dielectric portion on the lower common electrode, and
the lower common electrode and the upper common electrode are coupled electrically to the dielectric portions via the electrodes of the capacitor components.
